(19) United States
(12) Patent Application Publication
(10) Pub. No.: US 2025/0377445 A1
(43) Pub. Date: Dec. 11, 2025

(54) LIDAR SENSOR

(71) Applicant: Robert Bosch GmbH, Stuttgart (DE)

(72) Inventors: Alf Neustadt, Stuttgart (DE); Daniel Stricker-Shaver, Marnheim (DE); Markus Kienzle, Lehrensteinsfeld (DE); Sebastian Schweyer, Groebenzell (DE); Vitali Obholz, Ostfildern (DE)

(21) Appl. No.: 19/222,326

(22) Filed: May 29, 2025

(30) Foreign Application Priority Data
Jun. 10, 2024 (DE) 10 2024 205 344.9

(51) Int. Cl. G01S 7/4865; G01S 7/481; G01S 17/931

(52) U.S. Cl. CPC G01S 7/4865; G01S 7/4813; G01S 7/4816; G01S 7/4817; G01S 17/931

(57) ABSTRACT

A lidar sensor including a transmitting unit, a receiving unit, a protective window, a housing, and a deflecting unit. The transmitting unit generates laser beams during respective measuring processes and emits them into an environment of the lidar sensor, the receiving unit includes at least a first light-sensitive region and a second light-sensitive region, and is configured to receive, within a first time period after the start of the emission of a particular laser beam, reflected portions of the particular laser beam within the first light-sensitive region and, within a second time period, to receive reflected portions of the particular laser beam within the second light-sensitive region.

### FIELD

The present invention relates to a lidar sensor and in particular to a lidar sensor of an environment detection system of a vehicle.

### BACKGROUND INFORMATION

Certain so-called “time-of-flight” (TOF) lidar sensors are described in the related art, which are configured to ascertain distances of objects in the environment of the lidar sensors on the basis of a measured time-of-flight of laser pulses emitted into an environment of the lidar sensors.

Furthermore, certain scanning lidar sensors such as point or line scanners are described in the related art, which are configured to successively scan a field of view of the lidar sensors on the basis of a point-shaped or line-shaped laser beam.

Typically, such lidar sensors have a protective glass arranged in a wall of a housing of the lidar sensors, in order to protect an interior of the lidar sensors from external influences (e.g., dust, moisture, etc.), while the protective glass serves as an optical interface for the exit and entry of laser light used for measurements by the lidar sensors.

U.S. Patent No. 10,830,879 B2 describes an optical measuring device that is configured to detect a target scene on the basis of one or more emitted light pulses, wherein a control circuit of the optical measuring device is configured to adapt, according to a distance of regions of the target scene illuminated by the optical measuring device, a region within an arrangement of measuring elements onto which the target scene is mapped in the optical measuring device.

### SUMMARY

A lidar sensor according to the present invention, which is designed in particular as a “time-of-flight” lidar sensor that uses a time-of-flight measurement method for detecting an environment, includes, among other things, a transmitting unit, a receiving unit, a protective window, a housing, and a deflecting unit.

Furthermore, according to an example embodiment of the present invention, the lidar sensor is advantageously designed as a lidar sensor for a vehicle (e.g., car, truck, bus, van, etc.), which is configured on the basis of a suitable arrangement on such a vehicle to detect at least a partial region of an environment of the vehicle for environment recognition. On the basis of such environment recognition, driver assistance systems and/or systems for (partially) automated driving can be realized, for example.

Furthermore, according to an example embodiment of the present invention, the lidar sensor is preferably a lidar sensor that comprises different optical paths for the transmitting unit and the receiving unit, i.e., a lidar sensor that is not designed as a so-called coaxial lidar sensor.

According to an example embodiment of the present invention, the transmitting unit, the receiving unit, and the deflecting unit are arranged within the housing and the protective window is integrated into a cutout in a wall of the housing, wherein the protective window is designed as an optical interface for respective measurement signals of the lidar sensor and as a protective element for an interior of the housing.

According to an example embodiment of the present invention, the transmitting unit is configured to generate pulsed laser beams during the respective measuring processes by the lidar sensor and to emit these via the deflecting unit through the protective window into an environment of the lidar sensor.

The deflecting unit is configured to move the laser beams within a field of view of the lidar sensor in order to scan the environment within the field of view. The deflecting unit is also configured to direct portions of the emitted laser beams reflected in the environment to the receiving unit. The deflecting unit is designed, for example, as a rotating deflecting unit that has at least one mirror acting as a deflecting surface, without limiting the deflecting unit to such a design. Depending on the form of the lidar sensor, the deflecting unit can be configured to deflect an incident laser beam one-dimensionally and/or two-dimensionally into the environment of the lidar sensor.

According to an example embodiment of the present invention, the receiving unit comprises, within a light-sensitive surface of the receiving unit, at least a first light-sensitive region, which can also be referred to as the first channel, and a second light-sensitive region that deviates from the first light-sensitive region, which can also be referred to as the second channel. Particularly preferably, the receiving unit comprises further light-sensitive regions or channels in order to be able to achieve the effect according to the present invention described below with particular efficiency. The light-sensitive surface is preferably composed of an arrangement of a plurality of light-sensitive pixels (hereinafter also referred to as “pixels”) from which the different light-sensitive regions can be defined. The more light-sensitive regions are available, the more precisely a transition from one light-sensitive region in each case to an adjacent light-sensitive region can be adapted to the respective reflection angles or to the parallax effect in order to achieve a more uniform reception performance.

According to an example embodiment of the present invention, the receiving unit is configured to receive, within a first time period after the start of the emission of a particular laser beam (this time period may immediately follow the emission or have a predefined time delay in this regard), reflected portions of a laser light of the particular emitted laser beam within the first light-sensitive region and to generate a first signal that contains time-of-flight information with respect to the received reflected portions of the particular laser beam within the first time period.

According to an example embodiment of the present invention, the receiving unit is further configured to receive reflected portions of the particular emitted laser beam within the second light-sensitive region within a second time period following the first time period and to generate a second signal that contains time-of-flight information with respect to the received reflected portions of the particular laser beam within the second time period. Here, it is preferable that the second time period follows immediately after the first time period, without necessarily being limited to it.

Due to the use of at least two different light-sensitive regions (which may be disjoint regions or regions that partially overlap) and their suitable definition within the light-sensitive surface of the receiving unit, it is advantageously possible to map reflections generated in the environment of the lidar sensor, which are generated by near objects, predominantly onto the first light-sensitive region and to map reflections generated by more distant objects predominantly onto the second light-sensitive region. The reason for this is the different reflection angles of the laser beams in each case reflected in the environment according to the distance of the objects to be detected. This effect is also known as the parallax effect and accordingly causes the reflected laser light to be mapped onto different regions of the light-sensitive surface of the receiving unit depending on the distance.

“Near” objects can be understood, for example, as objects that lie within a first distance range emanating from the lidar sensor (e.g., up to 5 m, up to 10 m, up to 20 m or up to a distance deviating therefrom), while “more distant” objects can be understood, for example, as objects that lie within a second distance range that borders an end of the first distance range that is remote from the lidar sensor.

The use of different light-sensitive regions therefore makes it possible to improve the signal-to-noise ratio for the first signal and/or the second signal, since, in each case, the regions of the light-sensitive surface in which the highest incoming light energy is expected are used for reception. In particular, the resulting possible improvement in the signal-to-noise ratio of the first signal is advantageously sought according to the present invention, since in this way reflections of laser light from near objects (i.e., objects located in the immediate environment of the lidar sensor) can be better identified, since these are typically superimposed by unwanted reflections, which result in particular from scattering of the emitted laser beams by the protective window of the lidar sensor and/or from reflections, in particular multiple reflections, from further components of the lidar sensor within the lidar sensor.

Accordingly, it is particularly advantageous according to an example embodiment of the present invention if a duration of the first time period is defined to correspond to a time period during which scattering of the laser beam by the protective window can negatively affect the detection of near objects. The improved signal-to-noise ratio results from the fact that the laser light scattered by the protective glass on the receiving unit is typically scattered more widely than the reflected laser light received from the environment, so that the energy of the laser light scattered by the protective window and/or further components of the lidar sensor is distributed correspondingly more widely over the light-sensitive surface than the light reflected from the environment.

According to an example embodiment of the present invention, the lidar sensor is configured to generate a first output signal, which comprises a first signal and a second signal, which in each case were generated on the basis of a first time period, and a second time period of the same laser beam, wherein the lidar sensor is configured to set a lower light sensitivity of the receiving unit within the first time period than in the second time period. As a result, it is achieved that the laser light scattered by the protective glass does not lead to saturation of light-sensitive pixels in the first light-sensitive region, or only for a correspondingly short time period, as a result of which undesired masking of portions of the emitted laser light reflected in the environment is reduced or prevented. Due to the use of such a reduced light sensitivity in the first time period and simultaneously using a light-sensitive region adapted to the reflection angles of near objects (i.e., the first light-sensitive region), the unwanted reflections from the protective window and/or further components of the lidar sensor can be more clearly distinguished from the reflections of near objects, as a result of which the recognition of near objects in the environment of the lidar sensor is improved or made possible in the first place.

The differentiation of the laser light reflected in the environment from the portions scattered by the protective window and/or further components of the lidar sensor can be realized, for example, on the basis of a threshold value, on the basis of which the lidar sensor is configured to use the respective signal values generated in each case by the light-sensitive pixels of the receiving unit only if they exceed the threshold value. By defining the threshold value and/or dynamically adapting it according to the respective boundary conditions in such a way that portions of the laser light scattered by the protective glass in each case generate signal values that at least lie predominantly below the threshold value, these can be reduced or suppressed accordingly.

Alternatively or additionally, the lidar sensor is configured to generate a second output signal, which comprises a first signal, which was generated on the basis of a first time period of a first laser beam, and a second signal, which was generated on the basis of a second time period of a second laser beam following the first laser beam (this does not necessarily have to be a laser beam immediately following the first laser beam, but this is advantageous), wherein the lidar sensor is configured to set an average transmission energy of the first laser beam in the transmitting unit to be lower than an average transmission energy of the second laser beam.

As a result, as described above, a reduction or avoidance of saturation of the light-sensitive pixels by the laser light scattered by the protective glass is likewise achieved, as a result of which the above-described distinction between laser light reflected in the environment and laser light unintentionally reflected by the protective window and/or further components of the lidar sensor is likewise improved or made possible. The distinction can preferably also be made on the basis of a threshold value as described above.

It should be noted in general that control of the transmitting unit and/or the receiving unit and/or the deflecting unit and/or the generation of the first output signal and/or the second signal, etc., can be realized using one or more control units of the lidar sensor.

Furthermore, according to an example embodiment of the present invention, it is possible that the lidar sensor is configured to change the light sensitivity of the receiving unit at a point in time that deviates from a point in time of transition from the use of the first light-sensitive region to the use of the second light-sensitive region. Such a deviation in the points in time may be due to technical limitations and/or be an intentional deviation. Technical limitations arise, for example, from the fact that the respective switching times can only be synchronized to a limited extent and/or from the fact that switching between the respective light-sensitive regions can be carried out almost immediately, while an adaptation of the light sensitivity of the receiving unit is carried out gradually, i.e., over a certain period of time.

In this connection, it may be advantageous for the adaptation of the light sensitivity of the receiving unit to be deliberately carried out more slowly than necessary, in order to achieve, for example, the most uniform sensitivity possible over distance.

For this purpose, according to an example embodiment of the present invention, the lidar sensor is designed, for example, in such a way that within the second time period a sensitivity of the receiving unit is gradually set to a maximum sensitivity, which is achieved, for example, at a measuring distance of the lidar sensor of 5 m to 15 m, without thereby limiting it to this value range.

It should also be noted that the first signal and/or the second signal and/or the first output signal and/or the second output signal can, in principle, represent information about respective brightness values that are generated by the light-sensitive pixels of the receiving unit in any desired form. For example, it is possible that the first signal and the second signal represent respective histograms for the first time period and the second time period, which can be combined into an overall histogram in the course of the generation of the first output signal and/or the second output signal, without thereby imposing a limitation with respect to a particular information representation by the respective signals.

Advantageously, according to an example embodiment of the present invention, the lidar sensor can also be configured to provide an environment recognition unit with the first output signal and/or the second output signal, so that objects in the environment of the lidar sensor can be detected and/or analyzed on the basis of the environment recognition unit. Such an environment recognition unit can, for example, be located away from the lidar sensor and/or integrated into the lidar sensor.

Preferred developments of the present invention are disclosed herein.

Further preferably, the lidar sensor is designed as a line scanner and/or as a point scanner and in particular as a macro scanner.

In an advantageous example embodiment of the present invention, the first light-sensitive region and the second light-sensitive region are in each case formed from at least one pixel and/or at least one macropixel (i.e., a predefined grouping of a plurality of pixels) and/or at least one column or at least one row of a plurality of pixels and/or macropixels. In an exemplary case in which the lidar sensor is designed as a line scanner with a vertically radiating scan line, the first light-sensitive region can, for example, correspond to a first column of macropixels, while the second light-sensitive region can correspond to a second column of macropixels that deviates from the first column.

Advantageously, the lidar sensor is configured to set the average transmission energy of the first laser beam in the transmitting unit to be lower than the average transmission energy of the second laser beam by defining a pulse duration of the first laser beam to be shorter than a pulse duration of the second laser beam. As a result, it can be achieved that a temporal overlap between the laser light scattered by the protective window (and/or by further components of the lidar sensor) and the laser light reflected in the environment is reduced or even avoided, as a result of which the distinguishability of the particular laser light is improved or made possible. Alternatively or additionally, the lidar sensor is configured to define a transmission power of the transmitting unit during the generation of the first laser beam to be lower than during the generation of the second laser beam. Accordingly, the probability that saturation of the light-sensitive pixels by the first laser beam leads to masking of the received reflections of the second laser beam can be reduced.

According to an example embodiment of the present invention, particularly preferably, an end point in time of the first time period is defined according to the extent of scattering of the emitted laser beams by the protective window and/or by further components of the lidar sensor. Here, in particular, the energy and/or distribution and/or duration of the laser beams scattered by the protective glass can be taken into account. Alternatively or additionally, it is possible that the end point in time of the first time period is defined according to a minimum required measuring distance by the lidar sensor. In other words, the lidar sensor is preferably configured to automatically set the end point in time of the first time period on the basis of current boundary conditions, so that there is no adverse shift in the end point in time due to, for example, temperature effects, etc.

In a further preferred example embodiment of the present invention, the first light-sensitive region and the second light-sensitive region are in each case formed on the basis of SPAD, APD, or SiPM technology or on the basis of a technology of an unamplified photodiode (e.g., a PIN diode, CMOS). In particular, due to the high light sensitivity associated with these technologies, which can easily lead to undesired saturation of the light-sensitive pixels due to scattering by the protective glass, the use of the lidar sensor according to the present invention offers a particular advantage in the recognition of objects in the near range of the lidar sensor.

In a further example embodiment of the present invention, the first light-sensitive region is a predefined region within the light-sensitive surface of the receiving unit. The definition of the predefined region can, for example, be carried out in the course of production of the lidar sensor and in particular on the basis of an evaluation of a measurement in order to define in each case the most suitable pixels for the first light-sensitive region. The most suitable pixels may preferably be the pixels which are most strongly irradiated by reflections of the laser light from near objects.

In a further advantageous example embodiment of the present invention, the lidar sensor is configured to adapt the first region according to a reflection angle of the particular laser beam on a (near) object in the environment of the lidar sensor by defining a partial region of a light-sensitive surface of the receiving unit corresponding to the reflection angle as the first region. Such a dynamic definition of the first region can be achieved, for example, by evaluating the pixels of the light-sensitive surface by, in each case, assigning to the first region the pixels which are currently exposed to the highest light energy. As described above, it is also possible to define additional light-sensitive regions in order to select, in each case, the most suitable pixels for different distances in order to achieve the highest possible signal-to-noise ratio for the signal generated by the receiving unit.

According to an example embodiment of the present invention, particularly advantageously, the lidar sensor is configured to carry out respective measuring processes on the basis of the first laser beam with a shorter overall duration than respective measuring processes on the basis of the second laser beam. This applies accordingly to the case where the second output signal is to be provided by the lidar sensor. This offers the advantage that the temporal resolution of conventional measurements of distant objects on the basis of the second laser beam is not reduced or is reduced only to a lower extent, since the intermediate measurements on the basis of the first laser beam exhibit a correspondingly shorter duration.

In a further advantageous example embodiment of the present invention, the lidar sensor is configured to generate the second output signal only if predefined boundary conditions are met. Possible boundary conditions include, for example, a current traffic situation and/or a maneuvering situation that affect a vehicle that is using the lidar sensor according to the present invention. Preferably, the lidar sensor is configured to prevent alternating measurements on the basis of the first laser beam and the second laser beam, in each case with different average transmission energies, in phases in which the predefined boundary conditions are not met, so that in these phases only conventional measurements on the basis of laser beams with identical average transmission energies are carried out in order to be able to reliably detect distant objects. This accordingly means that measurement on the basis of the different average transmission energies is only applied if reliable detection of near objects is also required. This avoids, among other things, a reduction in the temporal resolution of measurements of distant objects by interspersed measurements of near objects with lower average transmission energies in phases in which the detection of near objects is not relevant. Activating the measurement on the basis of the different average transmission energies, on the basis of which the second output signal is generated, can be particularly advantageously activated, for example, in starting situations and/or parking situations and/or in city traffic and/or when driving slowly, etc., since in these situations near objects are usually also relevant for environment recognition. However, during highway driving, etc., generating the second output signal may be less relevant and can therefore be deactivated in such situations. It is understood that examples of boundary conditions mentioned above in connection with a vehicle may be defined differently in other areas of application (in particular outside of a vehicle application). Alternatively or additionally, it is possible to generate the second output signal only if a predefined measuring interval for a measurement using the first laser beam has elapsed. This may mean that the measurements on the basis of the first laser beam can be performed with a lower frequency than the measurements on the basis of the second laser beam, for example after every second, third, fourth or x-th measurement on the basis of the second laser beam. As a result, the temporal resolution for the measurement on the basis of the second laser beam can be increased on average and/or the computing power required to generate the second output signal and/or the energy required to generate the additional first laser beams can be reduced on average.

### BRIEF DESCRIPTION OF THE DRAWINGS

In the following, exemplary embodiments of the present invention are described in detail with reference to the figures.

FIG. 1 is a schematic view of an embodiment of a lidar sensor according to the present invention.

FIG. 2 is a schematic view of a light-sensitive surface of a receiving unit of a lidar sensor according to an example embodiment of the present invention.

FIG. 3A shows a first exemplary histogram representing a time-of-flight measurement on the basis of a second laser beam, according to the present invention.

FIG. 3B shows a second exemplary histogram representing a time-of-flight measurement on the basis of a first laser beam, according to the present invention.

FIG. 3C shows a third exemplary histogram representing a second output signal, according to the present invention.

### DETAILED DESCRIPTION OF EXAMPLE EMBODIMENTS

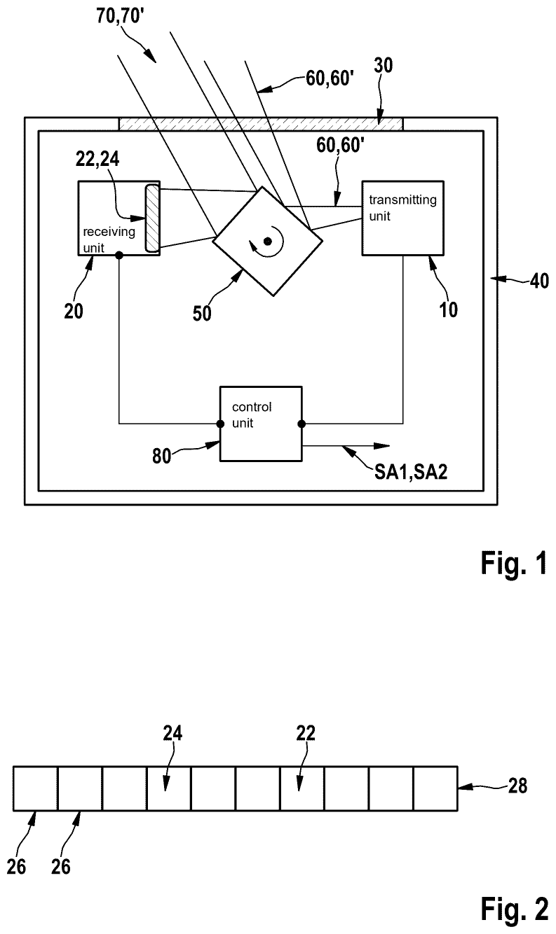

FIG. 1 is a schematic view of an embodiment of a lidar sensor according to the present invention, wherein the lidar sensor is designed here as a line scanner and is configured to be mounted on a vehicle for environmental detection and to be integrated into an on-board network of the vehicle.

The lidar sensor comprises a transmitting unit 10, a receiving unit 20, a protective window 30, a housing 40, a deflecting unit 50 and a control unit 80 designed as an ASIC, wherein the deflecting unit 50 is a rotatable deflecting unit that is configured to be set in rotation on the basis of an actuator (not shown) and on the basis of control by the control unit 80.

The transmitting unit 10, the receiving unit 20, the deflecting unit 50 and the control unit 80 are arranged within the housing and the protective window 30 is integrated into a cutout in a wall of the housing 40.

The transmitting unit 10 is configured, on the basis of control by the control unit 80, to generate pulsed laser beams (60, 60′) during respective measuring processes and to emit them via the deflecting unit 50 through the protective window 30 into an environment of the lidar sensor.

The deflecting unit 50 is configured to move the laser beams 60, 60′ within a field of view of the lidar sensor on the basis of the rotation described above in order to successively scan the environment within the field of view.

The receiving unit 20 comprises a first light-sensitive region 22 and a second light-sensitive region 24 that deviates from the first light-sensitive region 22 and that are defined within a light-sensitive surface (a pixel arrangement) of the receiving unit 20.

On this basis, the receiving unit 20 is configured to receive, within a first time period after the start of the emission of a first laser beam 60 and a second laser beam 60′ following the first laser beam 60, reflected portions 70 of the first laser beam 60 and reflected portions 70′ of the second laser beam 60′ within the first light-sensitive region 22 and to generate a first signal that contains time-of-flight information with respect to the received reflected portions 70, 70′ of the respective laser beams 60, 60′ within the first time period.

The receiving unit 20 is further configured to receive reflected portions 70, 70′ of the particular emitted laser beam 60, 60′ within the second light-sensitive region 24 within a second time period following the first time period and to generate a second signal that contains time-of-flight information with respect to the received reflected portions 70, 70′ of the particular laser beam 60, 60′ within the second time period.

The lidar sensor is configured on the basis of the control unit 80 to generate a first output signal SA1, which comprises a first signal and a second signal, which in each case were generated on the basis of a first time period, and a second time period of the same laser beam 60, wherein the lidar sensor is configured on the basis of the control unit 80 to set a lower light sensitivity of the receiving unit 20 within the first time period than in the second time period.

Alternatively or additionally, the lidar sensor is configured on the basis of the control unit 80 to generate a second output signal SA2, which comprises a first signal, which was generated on the basis of a first time period of a first laser beam 60 and a second signal S2, which was generated on the basis of a second time period of a second laser beam 60′ following the first laser beam 60, wherein the lidar sensor is configured on the basis of the control unit 80 to set an average transmission energy of the first laser beam 60 in the transmitting unit 10 to be lower than an average transmission energy of the second laser beam 60′.

For the aforementioned control and signal processing operations, the control unit 80 is in each case communicatively communicatively and/or electrically connected to the transmitting unit 10, the receiving unit 20, and the actuator (not shown) for the deflecting unit 50.

The control unit 80 is further configured to transmit the first output signal SA1 and/or the second output signal SA2 to a higher-level computing unit (not shown) of an environment recognition system.

FIG. 2 is a schematic view of a light-sensitive surface of a receiving unit 20 of a lidar sensor according to the present invention. The light-sensitive surface is designed here, for example, as a row 28 of a plurality of macropixels 26, wherein each macropixel is composed of a plurality of SPAD-based light-sensitive individual pixels (not shown).

FIG. 2 further shows a first light-sensitive region 22 that, due to the parallax effect, is particularly suitable for receiving laser beams that are reflected from objects in the near range of the lidar sensor, while the second light-sensitive region 24, due to the parallax effect, is particularly suitable for receiving laser beams that are reflected from more distant objects in the environment of the lidar sensor.

It should be noted that in particular the first light-sensitive region 22 can be dynamically adapted according to current boundary conditions.

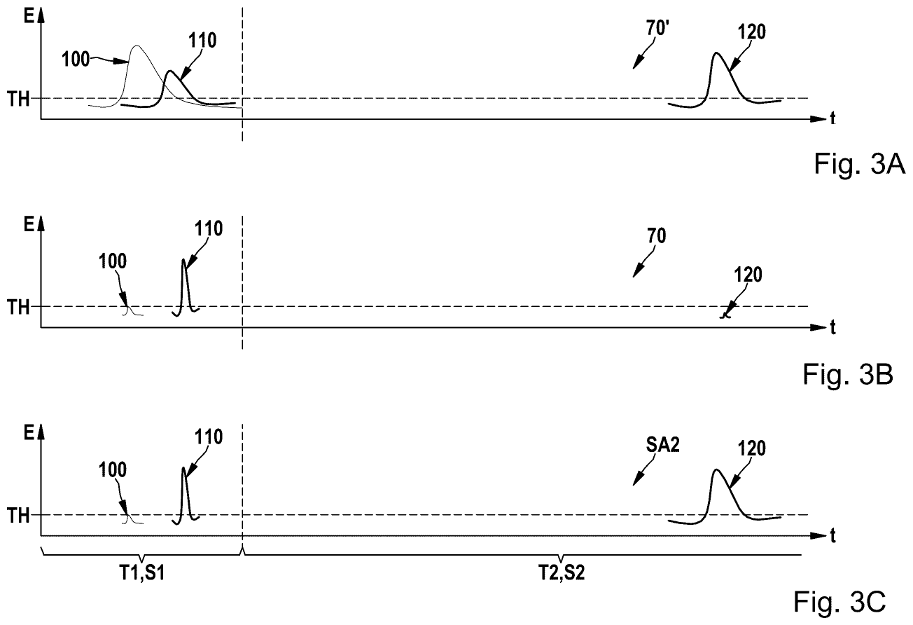

FIG. 3A shows a first exemplary histogram representing a time-of-flight measurement on the basis of a second laser beam 60′ (see FIG. 1), which is generated with a higher average transmission energy than a first laser beam 60 (see FIG. 1) underlying the following FIG. 3B. Specifically, FIG. 3A shows reflected portions 70′ of the second laser beam 60′ over time, wherein the vertical axis of the diagram in FIG. 3A represents the energy of the detected light in each case.

The average transmission energy of the second laser beam 60′ is designed for reliable detection of objects at a greater distance (e.g., up to 300 m) from the lidar sensor, so that reflections 100 that are generated by the protective window 30 (see FIG. 1) and/or further components of the lidar sensor within the lidar sensor can at least partially overshadow reflections 110 that are generated by near objects in the environment of the lidar sensor. As a result, reliably distinguishing between the reflections 100 and the reflections 110 on the basis of a comparison with a detection threshold TH may be made more difficult or impossible.

In addition, a first time period T1, in which the above-described superpositions can occur due to reflections 100 of the protective window 30 and/or further components of the lidar sensor, and a second time period T2, in which such superpositions do not occur, are identified. The components of the histogram that are assigned to the first time period T1 simultaneously represent a first signal S1 of the lidar sensor, while the components of the histogram that are assigned to the second time period T2 represent a second signal S2 of the lidar sensor.

FIG. 3B shows a second exemplary histogram representing a time-of-flight measurement on the basis of a first laser beam 60, the reflected portions 70 of which result in the histogram shown in FIG. 3B.

Since the first laser beam 60, which is emitted, for example, alternately with the second laser beam 60′, is generated with a lower average transmission energy compared to the second laser beam 60′ and at the same time a first light-sensitive region 22 (see FIG. 1) of a receiving unit 20 (see FIG. 1) of the lidar sensor is used in the first time period T1 and a second light-sensitive region 24 (see FIG. 1) that deviates from this is used in the second time period, a correspondingly higher energy results in the histogram for reflections 110 of the near object.

Accordingly, the reflections 110 of the near object can be distinguished from the reflections 100 of the protective window and/or the further components of the lidar sensor on the basis of a comparison with the detection threshold TH.

Due to the lower transmission energy of the first laser beam 60, corresponding reflections 120 with lower energy result for the distant object, which as a result can also fall below the detection threshold TH and thus cannot be detected or can no longer be reliably detected.

FIG. 3C shows a third exemplary histogram representing a second output signal SA2.

According to the present invention, the second output signal SA2 is composed of the first signal S1, which is generated on the basis of the first laser beam 60, and of the second signal, which is generated on the basis of the second laser beam 60′, so that both the reflections 110 of the near object and the reflections 120 of the distant object can be reliably detected.

1-10. (canceled)

11. A lidar sensor, comprising:
a transmitting unit;
a receiving unit;
a protective window;
a housing; and
a deflecting unit;
wherein:
the transmitting unit, the receiving unit, and the deflecting unit are arranged within the housing, and the protective window is integrated into a cutout in a wall of the housing;
the transmitting unit is configured to generate pulsed laser beams during respective measuring processes and to emit the generate pulsed laser beams via the deflecting unit through the protective window into an environment of the lidar sensor;
the deflecting unit is configured to move the laser beams within a field of view of the lidar sensor to scan the environment within the field of view,
the receiving unit includes at least a first light-sensitive region and a second light-sensitive region that deviates from the first light-sensitive region, and the receiving unit is configured:
within a first time period after a start of the emission of a particular laser beam, to receive reflected portions of the particular emitted laser beam within the first light-sensitive region and to generate a first signal that contains time-of-flight information with respect to the received reflected portions of the particular laser beam within the first time period,
to receive reflected portions of the particular emitted laser beam within the second light-sensitive region within a second time period following the first time period and to generate a second signal that contains time-of-flight information with respect to the received reflected portions of the particular laser beam within the second time period;
the lidar sensor is configured:
to generate a first output signal, which includes a first signal and a second signal, which in each case were generated based on the first time period, and the second time period of a same laser beam, wherein the lidar sensor is configured to set a lower light sensitivity of the receiving unit within the first time period than in the second time period, and/or
to generate a second output signal, which includes a first signal, which was generated based on the first time period of a first laser beam, and a second signal, which was generated base on a second time period of a second laser beam following the first laser beam, wherein the lidar sensor is configured to set an average transmission energy of the first laser beam in the transmitting unit to be lower than an average transmission energy of the second laser beam.

12. The lidar sensor according to claim 11, wherein the lidar sensor is a line scanner and/or a point scanner.

13. The lidar sensor according to claim 11, wherein the first light-sensitive region and the second light-sensitive region are in each case formed from
at least one pixel, and/or
at least one macropixel, and/or
at least one column or one row of a plurality of pixels and/or macropixels.

14. The lidar sensor according to claim 11, wherein the lidar sensor is configured to set the average transmission energy of the first laser beam in the transmitting unit to be lower than the average transmission energy of the second laser beam by:
defining a pulse duration of the first laser beam to be shorter than a pulse duration of the second laser beam, and/or
defining a transmission power of the transmitting unit during the generation of the first laser beam to be lower than during the generation of the second laser beam.

15. The lidar sensor according to claim 11, wherein an end point in time of the first time period is defined according to:
(i) an extent of scattering of the emitted laser beams by the protective window and/or by further components of the lidar sensor, and/or
(ii) a minimum required measuring distance by the lidar sensor.

16. The lidar sensor according to claim 11, wherein the first light-sensitive region and the second light-sensitive region are in each case formed based on SPAD technology or APD technology or SiPM technology or a PIN diode technology.

17. The lidar sensor according to claim 11, wherein the first light-sensitive region is a predefined region.

18. The lidar sensor according to claim 11, wherein the lidar sensor is configured to adapt the first region to an object in the environment of the lidar sensor according to a reflection angle of the particular laser beam by defining a partial region of a light-sensitive surface of the receiving unit (corresponding to the reflection angle as the first region.

19. The lidar sensor according to claim 11, wherein the lidar sensor is configured to carry out respective measuring processes based on the first laser beam with a shorter overall duration than respective measuring processes based on the second laser beam.

20. The lidar sensor according to claim 11, wherein the lidar sensor is configured to generate the second output signal only when:
predefined boundary conditions are met, and/or
a predefined measuring interval for a measurement using the first laser beam has elapsed.
